(19) United States
(12) Patent Application Publication
(10) Pub. No.: US 2023/0415864 A1
(43) Pub. Date: Dec. 28, 2023

(54) RENEWABLE ENERGY PLATFORM WITH OPTIMISED ASSEMBLY

(71) Applicant: Marine Power Systems Limited, Swansea South Wales (GB)

(72) Inventor: Graham David FOSTER, Swansea South Wales (GB)

(73) Assignee: Marine Power Systems Limited, Swansea South Wales (GB)

(21) Appl. No.: 18/463,688

(22) Filed: Sep. 8, 2023

Related U.S. Application Data
(63) Continuation of application No. PCT/EP22/56391, filed on Mar. 11, 2022.

(30) Foreign Application Priority Data
Mar. 11, 2021 (GB) 2103365.9
Sep. 15, 2021 (GB) 2113192.5

(51) Int. Cl. B63B 75/00; B63B 21/50

(52) U.S. Cl. CPC B63B 75/00; B63B 21/502; B63B 2035/446

(57) ABSTRACT

An offshore renewable energy system mounting platform is provided for positioning a renewable energy converter in a body of water. The platform includes a frame having a first structural member and a second structural member that are positioned adjacent one another at a mating connection and at least one mooring member affixed to the frame at a tethering location which is tethers the frame to a bed of the body of water. Either the first or second structural members comprises a buoyancy and a tension in the mooring member is arranged to counteract the buoyancy to urge the first and second structural members together at the mating connection. The platform may be manufactured as a set of pre-fabricated modular components which are subsequently assembled into the complete platform.

### CROSS REFERENCE TO RELATED APPLICATIONS

This continuation application claims priority benefit from International Application No. PCT/EP2022/056391 filed on Mar. 11, 2022, which claimed priority from Great Britain Application No. 2103365.9 filed Mar. 11, 2021 and Great Britain Application No. 2113192.5 filed Sep. 15, 2021, which are all incorporated herein by reference in their entireties.

### FIELD OF THE INVENTION

The present disclosure relates to a renewable energy system mounting platform, and in particular to a platform arranged to support a renewable energy harnessing device while at least a portion of the platform and/or the renewable energy harnessing device are submerged in a body of water.

### BACKGROUND OF THE INVENTION

The world is transitioning to renewable energy—this transition will require the exploitation of all forms or renewable energy to provide the planet with energy it needs.

One potential renewable energy source is wave power—an abundant and consistent energy resource available in all the world's large oceans and seas. Another is wind power, with wind speeds being higher and more consistent over oceans and seas compared to land.

For these reasons, offshore platforms providing means to mount renewable energy devices which harness wave and/or wind power in deep water are required.

The cost of the platforms directly influences the cost of energy produced by the devices therefore there is a need for platforms that are cost effective to manufacture and assemble.

In particular there is a need for platforms that can been manufactured as a set of pre-fabricated modular components in a wide supply chain, which are subsequently assembled into the complete platform at non-specialist outdoor yard facilities without the need for specialist shipbuilding facilities, and which does not compromise on stability when deployed.

### SUMMARY OF THE INVENTION

The present invention provides an offshore renewable energy system mounting platform for positioning a renewable energy converter in a body of water, the platform comprising a plurality of discrete pre-fabricated components which are held in engagement with one another under the counteracting forces of: buoyancy provided by one or more of said components; with the effects of gravity acting on the mass of said components and a mooring force applied by a mooring member tethering the platform to a bed of a body of water. The discrete components of the platform are preferably minimal in number and in type in order to simply manufacture, assembly and maintenance. The components are preferably manufactured such that they interact at mating connections which hold the components together under gravity and/or said counteracting forces alone, during a stepwise assembly process optionally prior to a permanent fixing being applied to reinforce said mating connections.

In accordance with a first aspect of the present invention, there is provided an offshore renewable energy system mounting platform for positioning a renewable energy converter in a body of water, the platform comprising: a frame having a first structural member and a second structural member, the first and second structural members positioned adjacent one another at a mating connection; and at least one mooring member affixed to the frame at a tethering location, the at least one mooring member arranged to tether the frame to a bed of the body of water in an in-use configuration; wherein at least one of the first and second structural members comprises a buoyancy; and wherein in the in-use configuration, a tension in the mooring member is arranged to counteract said buoyancy to urge and/or bias the first and second structural members together at the mating connection.

The mating connection may in some embodiments be such that when one or more of said counteracting forces are removed, the first and second structural members may be disengaged. Said tension may supplement, or may be replaced in some embodiments by, the effect of gravity on said components of the platform and/or the renewable energy converter.

In preferable embodiments, in the in-use configuration, at least a portion of the frame is preferably submerged in the body of water. When submerged, the buoyancy of the first and/or second structural member preferably acts against the tension in the mooring member to provide stability to the platform and urge and/or bias the first and second structural member together at the mating connection.

The frame preferably further comprises a temporary or permanent mechanical fixing arranged to affix the first and second structural members together at the mating connection. The temporary or permanent mechanical fixing may be applied to reinforce the mating connection, providing longer term rigidity and stability to the platform in use. In preferable embodiments, said affixing is arranged to occur prior to and/or during a deployment of the platform to the in-use configuration. Said temporary or permanent mechanical fixing may be used to stabilize the platform, in a temporary or permanent manner during transport or deployment of the platform to the in-use configuration.

The first structural member preferably forms a base portion of the frame and wherein the second structural member forms an upper portion of the frame, wherein the tethering location is preferably located on the second structural member. In most preferable embodiments, the first structural member comprises a said buoyancy. In some preferable embodiments, the second structural member may also, or instead, comprise a said buoyancy. In most preferable embodiments having the tethering location positioned on the second structural member, the first structural member preferably comprises said buoyancy. As such, the counteracting forces of said buoyancy and tension better urge and/or bias the first and second structural elements together at the mating connection when the platform is in the in-use configuration.

In most preferable embodiments, the first structural member comprises a subassembly of one or more first braces. Each of the one or more first braces preferably comprises a mating feature located at each end of the respective first brace, each said mating feature arranged to engage a corresponding mating feature of an adjacent first brace to provide the mating connection.

In preferable such embodiments, each said first brace comprises a first mating feature type located at one end thereof, and a second different mating feature type located at a second end thereof, the first mating feature type arranged to engage an end of an adjacent first brace having the second mating feature type. The first mating feature type is therefore complementary to the second mating feature type, and may permit overlapping mating wherein a mating feature of each first brace overlaps one or both of the mating features of the adjacent braces. Said complementary engagement is arranged to hold the adjacent first braces together, for example under gravity alone, such that said first braces are held stationary in at least a single plane relative to one another, and such that they may be urged and/or biased more tightly together under a load, such as under the load provided by gravity, a weight of a renewable energy converter supported thereon and/or the tension of the mooring lines counteracting the buoyancy, or any combination thereof. The engagement may be such that the braces are arranged to be disengaged by a lifting force acting perpendicular to the single plane and in an opposite direction to said load. In such embodiments having complementary mating feature types on a single said first brace, multiple identical said first braces may preferably form the first structural member such that manufacture, assembly and maintenance are simplified.

The second structural member preferably comprises one or more second braces, each of the one or more second braces having a first end comprising a mating feature arranged to engage the first structural member at the mating connection. Said engagement is preferably complementary. In some embodiments, the combined engagement of the first and second mating feature types of the first structural member may provide a combined mating feature which is complementary to said mating feature of the second brace, such that the engagement therebetween holds the adjacent braces together, for example under gravity alone. Said engagement is preferably such that the adjacent braces are held stationary relative to one another in at least a single plane, and such that they may be urged and/or biased more tightly together under a load, such as under the load provided by gravity, a weight of a renewable energy converter supported thereon and/or the tension of the mooring lines counteracting the buoyancy, or any combination thereof. The engagement may be such that the braces are arranged to be disengaged by a lifting force acting perpendicular to the single plane and in an opposite direction to said load.

The frame in the in-use configuration preferably comprises a tetrahedral shape; wherein the first structural member forms a triangular base portion defined by three said first braces; and wherein the second structural member forms an upper portion defined by three said second braces, each extending from the mating connection of said triangular base. The tetrahedral shape provides an optimum stability for the platform. The triangular base of first braces is preferably comprised of buoyant said first braces such that a stable center of buoyancy of the platform is positioned beneath the upper vertex of the tetrahedral frame, preferably conferring maximal stability to the platform in use.

The frame preferably further comprises a transition member arranged to connect each of the second braces at an end thereof distal to the triangular base portion. The transition member is preferably arranged to support a said renewable energy converter thereon. The transition member is preferably comprised as part of the second structural element, and in embodiments comprising said transition member, the tethering location is preferably location on the transition member, thereby preferably conferring the downward tensional forces from the mooring member to the transition member, counteracting said buoyancy, such that the first and second structural members are held together.

In most preferable embodiments, at least one of the first braces comprises a said buoyancy. In some embodiments, at least one of the second braces may also, or instead, comprise a said buoyancy. In some preferable embodiments, all of the first braces and optionally all of the second braces comprise a said buoyancy.

In preferable embodiments, all of the first braces are identical. In some embodiments, all of the second braces are identical. The provision of identical braces preferably simplifies manufacture, assembly and maintenance, requires less tooling and provides fewer manufacturing and assembly errors.

The platform is preferably arranged to be assembled in discrete steps and throughout each of said discrete steps the platform is arranged to be self-supporting and free standing, preferably under gravity alone.

The components of the platform preferably each comprise a mating feature arranged to accept or engage with a complementary mating feature of an adjacent said component.

The acceptance or engagement between the complementary mating features preferably holds the adjacent components together such that they are held stationary in a plane relative to one another, and such that they may be urged and/or biased more tightly together under a load, such as under the load provided by the tension of the mooring lines counteracting the buoyancy. The acceptance or engagement may be such that the components may be disengaged by a lifting force acting perpendicular to the plane and in an opposite direction to said load. The components may subsequently be permanently affixed to one another by a permanent fixing in the in-use configuration.

In accordance with further embodiments, an offshore renewable energy system mounting platform may be provided for positioning a renewable energy converter in a body of water, the platform comprising: a tetrahedral frame having: a triangular base portion comprising three elongate first braces forming a mating connection at each vertex of said triangular base portion, at least one of the first braces comprising a buoyancy; an upper portion comprising three elongate second braces, each of the three elongate second braces extending from and engaged at a first end thereof with, a corresponding said mating connection; a transition member positioned engaged with a second end of each of the second braces and forming an upper tip of the tetrahedral frame, the transition member arranged to support the renewable energy converter thereon; the platform further comprising: a mooring member affixed to a tethering location positioned on the upper portion and/or the transition member, and arranged to tether the frame to a bed of the body of water in an in-use configuration; and wherein in the in-use configuration, a tension provided by the mooring member is arranged to counteract said buoyancy to urge and/or bias the base portion and the upper portion together at the mating connection.

It will be appreciated that any features described herein as being suitable for incorporation into one or more aspects or embodiments of the present disclosure are intended to be generalizable across any and all aspects and embodiments of the disclosure.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1 depicts a perspective view of an example embodiment of a platform, in accordance with an aspect of the present disclosure;

FIG. 2 depicts a close-up perspective view of the frame of the platform of FIG. 1, in accordance with an aspect of the present disclosure;

FIG. 3 depicts an exploded view of the frame of FIG. 2, in accordance with an aspect of the present disclosure;

FIG. 4 depicts a perspective view of each of the distinct components comprised within the frame of FIG. 2 and FIG. 3, in accordance with an aspect of the present disclosure;

FIG. 5A to FIG. 5D depicts a stepwise assembly process for assembly of the frame of FIG. 2, in accordance with an aspect of the present disclosure;

FIG. 6 depicts a close-up perspective view of a permanent mechanical fixing applied to a mating connection between the first and second braces of the frame of FIG. 2, in accordance with an aspect of the present disclosure; and

FIG. 7 depicts a close-up perspective view of a permanent mechanical fixing applied to a mating connection between the second braces and the transition member of the frame of FIG. 2, in accordance with an aspect of the present disclosure.

### DETAILED DESCRIPTION FOR CARRYING OUT THE INVENTION

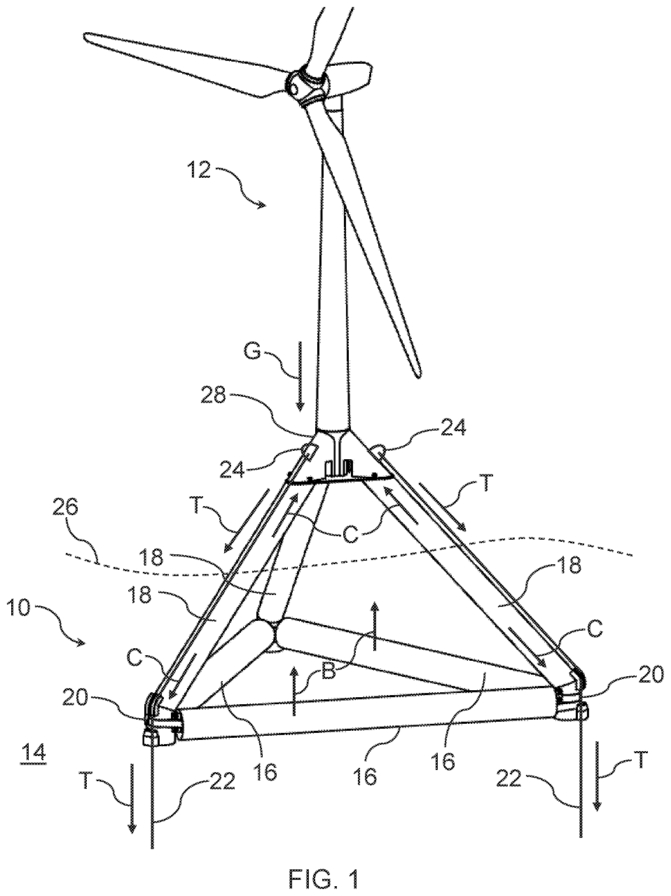

With reference to FIG. 1, an example embodiment of an offshore renewable energy system mounting platform 10 in accordance with the first aspect is shown, for positioning a renewable energy converter 12 in a body of water 14. The platform 10 comprises a frame having a first structural member 16 and a second structural member 18. The first and second structural members 16, 18 are positioned adjacent to one another at a mating connection 20. At least one mooring member 22 is provided affixed to the frame at a tethering location 24, the at least one mooring member 22 being arranged to tether the frame to the bed of the body of water 14 in an in-use configuration shown in FIG. 1. In the embodiment shown, the first structural member 16 comprises a buoyancy B, such that in the in-use configuration shown, a tension T in the mooring member 22 is arranged to counteract said buoyancy B to urge the first and second structural members 16, 18 together at the mating connection 20.

In the particular example embodiment shown in FIG. 1, the platform 10 comprises a tetrahedral frame having a triangular base portion comprising three elongate first braces 16 forming a mating connection 20 therebetween at each vertex of said triangular base portion. In the example shown in FIG. 1, all of the first braces 16 comprise said buoyancy B such that in the in-use configuration shown, wherein a portion of the platform 10 is submerged beneath a surface 26 of the body of water 14, the buoyancy B acts to urge the first braces 16 upwards in the body of water 14. The frame further comprises an upper portion having three elongate second braces 18, each of the three elongate second braces 18 extending from and engaged at a first end thereof with, a corresponding said mating connection 20; and a transition member 28 positioned engaged with a second end of each of the second braces 18 and forming an upper tip of the tetrahedral frame. The transition member 18 in the embodiment shown is arranged to support the renewable energy converter 12 thereon, which in the example shown is a wind turbine. In the particular embodiments shown, the tethering location 24 of the mooring member 22 is positioned on the transition member 28 such that in the in-use configuration shown with the base portion submerged beneath the surface 26 of the body of water 14, the tension T provided by the mooring member 22 is arranged to counteract the positive buoyancy B of the base portion, to urge the base portion and the upper portion together at the mating connections 20. The counteracting buoyancy B and tension T forces act to impose a compression force C on the second braces 18 of the upper portion of the frame at all times, thereby maintaining the mating connections 20 at which the upper portion and the base portion join. The tension T in the mooring member 22, counteracting the buoyancy B in the embodiment shown, is supplemented by the effects of gravity G on the mass of the components of the platform 10 and the wind turbine 12. In some embodiments, the tension T may be replaced or substituted by said effects of gravity G.

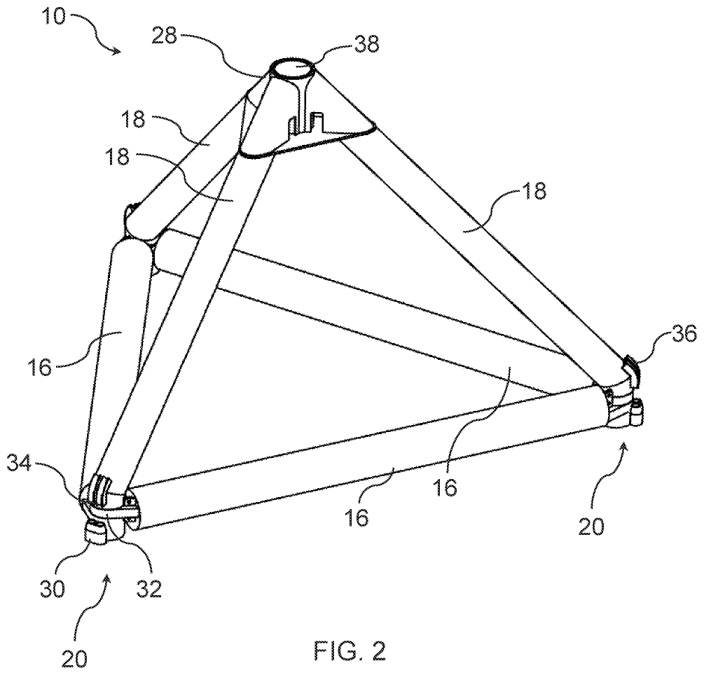

Referring to FIG. 2, a close-up view of the platform 10 of FIG. 1 is shown, with the mooring member removed. The tetrahedral frame is formed by a base portion comprising the three elongate first braces 16, which in the example shown are each identical. At a first end of each said first brace 16 is a first mating feature type 30, and at a second end of the first brace 16, opposing the first end, is positioned a second mating feature type 32. The first mating feature type 30 is complementary to the second mating feature type 32 and as such the second mating feature type 32 is arranged to engage the first mating feature type 30 during assembly of the frame. The engagement of the first and second mating feature types 30, 32 of the three first braces 16 is such that when each first brace 16 is in engagement with the two other first braces 16, the first braces 16 are held stationary relative to one another in at least one plane. This type of engagement preferably aids a stepwise assembly of the frame, and forms a stable mating connection 20 for attachment of the second braces 18. The identical nature of the first braces 16 in the embodiment shown also preferably simplifies manufacture, service and replacement of the first braces 16. At one end of each of the second braces 18 is positioned a third mating feature type 34, which is complementary to the combined first and second mating feature types 30, 32, such that when engaged therewith at the mating connection 20, said ends of the second braces 18 are held stationary relative to the first braces 16 in at least one plane, such that movement relative thereto is inhibited. This type of engagement preferably aids any said stepwise assembly of the frame. The second braces 18 are each identical, preferably simplifies manufacture, service and replacement of the second braces 16.

In the platform embodiment shown, proximate said mating connection end of the second braces 18 is positioned a channel 36 arranged to guide the mooring member (not shown) from the tethering location (not shown) along the corresponding second brace 18 and over the sides of the platform 10 to be tethered to the bed of the body of water. The transition member 28 in the embodiment shown comprises a socket feature 38 arranged to accept a corresponding fixing of a renewable energy converter (not shown), such that the renewable energy converter is supported thereon. Embodiments will be appreciated wherein the transition member 28 comprises any suitable fixing arranged to support the renewable energy converter thereon.

The platform 10, taking the form of a frame subassembly, shown in FIG. 2, is in a state such that when submerged by the mooring member (not shown) to the in-use configuration shown in FIG. 1, each of the three single mating connections 20 between the first braces 16 and the corresponding second brace 18, and each of the single mating connections between the three second braces 18 and the transition member 28, are supported by the counteracting forces of the buoyancy B and the effects of gravity G and/or the tension T induced by the mooring member (not shown). The engagement of the individual frame components described is such that the components are held together in a stable, stationary fashion under such counteracting forces alone, such that permanent fixings may be used to reinforce the connections between components, in a quick and simple manner as a final assembly step in optional cases. Therefore, the stepwise assembly of the final platform is made simpler, reducing the assembly time and the incidence of assembly errors, which is crucial in applications where multiple said platforms are intended to be deployed.

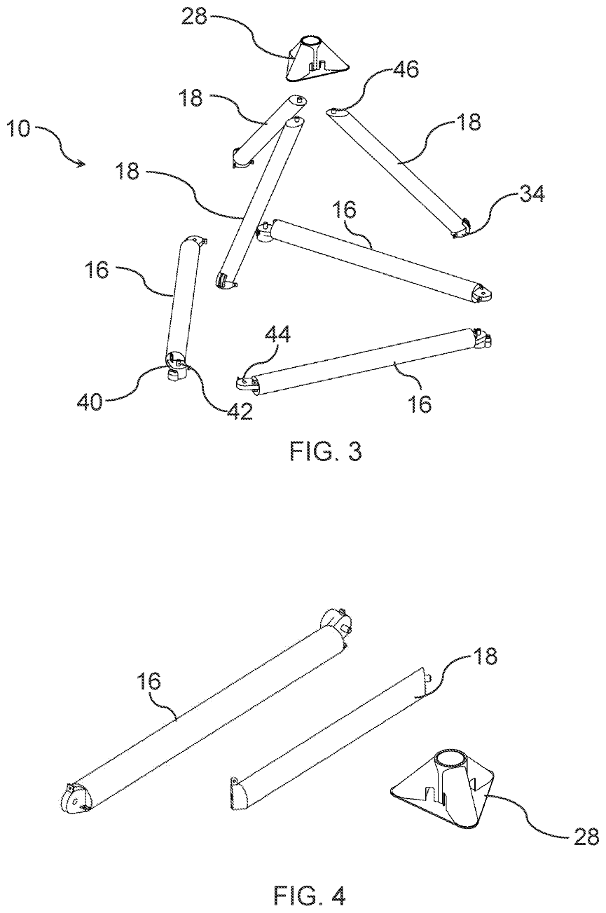

FIG. 3 shows an exploded view of the platform 10 depicted in FIG. 1 and FIG. 2. As shown in this particular embodiment, the first mating feature type 30 of the first braces 16 comprises a base 40 and a pin 42 extending therefrom. The second mating feature type 32 comprises a socket 44 which is located in a plane which is vertically offset from that of the base 40, such that said socket 44 may overlap the base 40, and rest stably thereon under gravity during assembly. The socket 44 is arranged to accept the pin 42 such that the pin 42 protrudes through, and extends beyond, the thickness of the socket 44. The third mating feature type 34 of the second braces comprises a socket (not shown) arranged to accept the portion of the pin 42 of the first mating feature type 30 protruding from the socket 44 of the second mating feature type 32. The end of the second braces 18 distal to the mating connection 20 comprises a fourth mating feature type comprising a pin 46 arranged to engage a corresponding socket (not shown) positioned on the underside of the transition piece 28. The engagement of the first braces 16 and a corresponding second brace 18 at the single mating connection 20 is therefore one which is supported by the counteracting forces of the buoyancy B and the effects of gravity G and/or tension T induced by the mooring member (not shown) alone, when deployed in the in-use configuration. Embodiments will be appreciated having any suitable mating features permitting urging of said mating features together under counteracting forces of buoyancy B and gravity effects G and/or mooring member tension T.

The example embodiment of platform 10 described therefore comprises only three distinct components as shown in FIG. 4, and a total of only seven individual said components, these being the first braces 16, the second braces 18 and the transition piece 28. This simplified arrangement preferably aids manufacture and assembly of the frame since a minimal number of distinct parts requires minimal tooling to produce, often produces fewer errors in manufacture, and acts to deskill the assembly process.

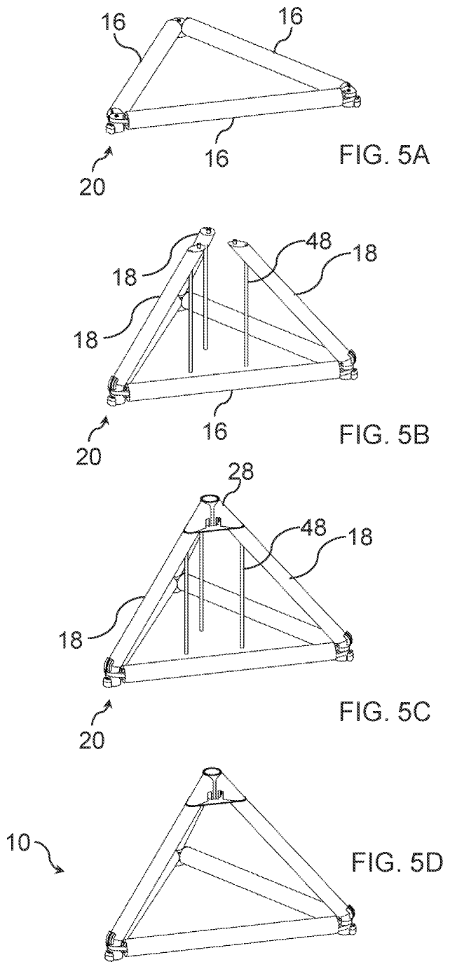

Referring to FIGS. 5A to 5D, a stepwise assembly process of the frame of the platform 10 is shown. The first step of the process as shown in FIG. 5A involves the engagement of complementary mating features of the first braces 16 as described earlier, to provide the triangular base portion of the tetrahedral frame comprising the three mating connections 20 positioned at the vertices thereof. This example process shown requires the simple overlapping of complementary mating features such that the features are held in a stationary engagement under gravity. In the subsequent step shown in FIG. 5B, each of the second braces 18 is placed into engagement with the corresponding mating connection 20 formed by the engaged first braces 16 of the triangular base portion. As shown in FIG. 5B, in the example process described the second braces 18 are temporarily supported in place by vertical supports 48, such that their engagement with the first braces 16 at the corresponding mating connection 20 is held in place under gravity. In a subsequent step shown in FIG. 5C, the transition member 28 is placed in engagement with corresponding ends of the second braces 18 to complete the upper portion of the frame, and is held in place under gravity. In a subsequent step shown in FIG. 5D, the vertical supports are removed and each assembled element remains in engagement under gravity alone. In practice the platform 10 subassembly shown in FIG. 5D would proceed to be transported on the surface of a body of water to a desired deployment location. With a mooring member attached to a tethering location, which in the embodiment described, would be positioned on the transition member 28, the frame would then be partially submerged beneath the surface of the body of water such that the buoyancy forces acting on the buoyant first braces would counteract a tension induced by the mooring member as described.

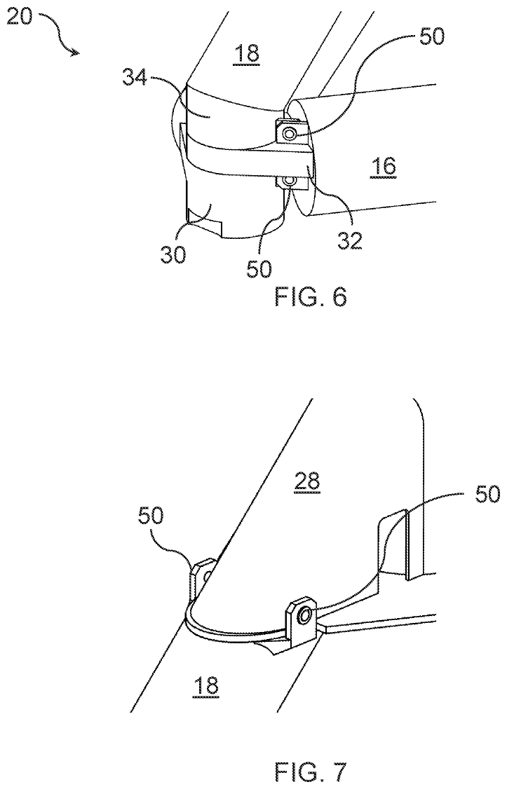

Once deployed to the in-use configuration shown in FIG. 1, a final step in the assembly of the platform may in some embodiments comprise the application of a permanent fixing 50 to the mating connections between the first and second braces 16, 18 shown in the close-up view of FIG. 6; and the mating connections between second braces 18 and the transition member 28 shown in the close-up view of FIG. 7. Such mechanical fixings 50 may in some embodiments be applied prior to said transport and/or deployment of the platform. In embodiments wherein said mechanical fixings 50 are applied before said transport and/or deployment, said mechanical fixings 50 may be temporary, and may be removed following said transport or deployment as an assembly step.

The triangular base formed by the buoyant first braces 16 in the example embodiment shown provides a center of buoyancy for the platform which is positioned on the plane of the triangular base and aligned with the tip of the tetrahedral frame defined by the transition member 28. The tension T provided by the mooring members 22 acts equally at each of the three vertices of the frame, such that in combination with the center of buoyancy, optimum stability of the platform within the body of water is provided and movement of the platform in the body of water is minimized once deployed to the in-use configuration exemplified by FIG. 1.

Further embodiments within the scope of the present disclosure may be envisaged that have not been described above, for example, there may be any combination of renewable energy convertors on the platform as described herein. The example embodiment is shown supporting a wind turbine, but any suitable renewable energy converter may be supported, for example a wave energy converter, or any combination of said suitable renewable energy converters. One, multiple or all vertices of the platform may support a said renewable energy convertor. In the example platform embodiment described, the first braces comprise a buoyancy. In other embodiments any number of the first braces and the second braces may comprise said buoyancy. In the example described, the platform comprises a first structural member having first braces which are all identical and a second structural member having second braces which are all identical. Embodiments will be appreciated wherein the platform comprises any suitable first and second structural members having a mating connection therebetween, said connection supported by the counteracting forces of buoyancy and the effects of gravity and/or tension induced by a mooring member. The frame in the example described takes a tetrahedral form, conferring a rigidity and stability inherent to such a form. Embodiments will be appreciated wherein the frame may take any suitable form within the scope of the appended claims. While the embodiment described includes as a final assembly step, the application of permanent fixings, embodiments will be appreciated wherein the mating connections between the first and second structural members supported by the counteracting forces of buoyancy and gravity and/or tension is sufficient to hold the structure together in a stable manner for the described application. The disclosure is not limited to the specific examples or structures illustrated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or system that “comprises,” “has,” “includes,” or “contains” one or more steps or elements possesses those one or more steps or elements, but is not limited to possessing only those one or more steps or elements. Likewise, a step of a method or an element of a system that “comprises,” “has,” “includes,” or “contains” one or more features possesses those one or more features, but is not limited to possessing only those one or more features. Furthermore, a system or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. An offshore renewable energy system mounting platform for positioning a renewable energy converter in a body of water, the platform comprising:
a frame having a first structural member and a second structural member, the first and second structural members positioned adjacent one another at a mating connection; and
at least one mooring member affixed to the frame at a tethering location, the at least one mooring member arranged to tether the frame to a bed of the body of water in an in-use configuration;
wherein at least one of the first and second structural members comprises a buoyancy; and
wherein in the in-use configuration, a tension in the mooring member is arranged to counteract said buoyancy to urge the first and second structural members together at the mating connection.

2. The offshore renewable energy system mounting platform of claim 1, wherein in the in-use configuration, at least a portion of the frame is submerged in the body of water.

3. The offshore renewable energy system mounting platform of claim 1, wherein the frame further comprises a temporary or permanent mechanical fixing arranged to affix the first and second structural members together at the mating connection.

4. The offshore renewable energy system mounting platform of claim 3, wherein said affixing is arranged to occur prior to and/or during a deployment of the platform to the in-use configuration.

5. The offshore renewable energy system mounting platform of claim 1, wherein the first structural member forms a base portion of the frame and wherein the second structural member forms an upper portion of the frame, wherein the tethering location is located on the second structural member.

6. The offshore renewable energy system mounting platform of claim 5, wherein the first structural member comprises a said buoyancy.

7. The offshore renewable energy system mounting platform of claim 6, wherein the second structural member comprises a said buoyancy.

8. The offshore renewable energy system mounting platform of claim 5, wherein the first structural member comprises a subassembly of one or more first braces.

9. The offshore renewable energy system mounting platform of claim 8, wherein each of the one or more first braces comprises a mating feature located at each end of the respective first brace, each said mating feature arranged to engage a corresponding mating feature of an adjacent first brace to provide the mating connection.

10. The offshore renewable energy system mounting platform of claim 9, wherein each said first brace comprises a first mating feature type located at one end thereof, and a second different mating feature type located at a second end thereof, the first mating feature type arranged to engage an end of an adjacent first brace having the second mating feature type.

11. The offshore renewable energy system mounting platform of claim 8, wherein the second structural member comprises one or more second braces, each of the one or more second braces having a first end comprising a mating feature arranged to engage the first structural member at the mating connection.

12. The offshore renewable energy system mounting platform of claim 8, wherein the frame in the in-use configuration further comprises a tetrahedral shape;
wherein the first structural member forms a triangular base portion defined by three said first braces; and
wherein the second structural member forms an upper portion defined by three said second braces, each extending from the mating connection of said triangular base.

13. The offshore renewable energy system mounting platform of claim 12, wherein the frame further comprises a transition member arranged to connect each of the second braces at an end thereof distal to the triangular base portion.

14. The offshore renewable energy system mounting platform of claim 13, wherein the transition member is arranged to support a said renewable energy converter thereon.

15. The offshore renewable energy system mounting platform of claim 8, wherein at least one of the first braces comprises a said buoyancy.

16. The offshore renewable energy system mounting platform of claim 11, wherein at least one of the second braces comprises a said buoyancy.

17. The offshore renewable energy system mounting platform of claim 11, wherein all of the first braces and the second braces comprise a said buoyancy.

18. The offshore renewable energy system mounting platform of claim 8, wherein all of the first braces are identical.

19. The offshore renewable energy system mounting platform of claim 11, wherein all of the second braces are identical.

20. The offshore renewable energy system mounting platform of claim 1, wherein the platform is arranged to be assembled in discrete steps and throughout each of said discrete steps the platform is arranged to be self-supporting and free standing.

21. The offshore renewable energy system mounting platform of claim 1, wherein the components thereof each comprise a mating feature arranged to accept or engage with a complementary mating feature of an adjacent said component.

22. An offshore renewable energy system mounting platform for positioning a renewable energy converter in a body of water, the platform comprising:
a tetrahedral frame having:
a triangular base portion comprising three elongate first braces forming a mating connection at each vertex of said triangular base portion, at least one of the first braces comprising a buoyancy;
an upper portion comprising three elongate second braces, each of the three elongate second braces extending from and engaged at a first end thereof with, a corresponding said mating connection; and
a transition member positioned engaged with a second end of each of the second braces and forming an upper tip of the tetrahedral frame, the transition member arranged to support the renewable energy converter thereon;
the platform further comprising:
a mooring member affixed to a tethering location positioned on the upper portion and/or the transition member, and arranged to tether the frame to a bed of the body of water in an in-use configuration; and
wherein in the in-use configuration, a tension provided by the mooring member is arranged to counteract said buoyancy to urge the base portion and the upper portion together at the mating connection.
